(19) United States
(12) Patent Application Publication
(10) Pub. No.: US 2008/0244861 A1
(43) Pub. Date: Oct. 9, 2008

(54) Stabilizer Bush

(76) Inventors: Yasuo Miyamoto, Saitama (JP); Kazutaka Suzuki, Saitama (JP); Yuji Yamazaki, Saitama (JP)

Correspondence Address: CARRIER BLACKMAN AND ASSOCIATES, 24101 NOVI ROAD, SUITE 100, NOVI, MI, 48375, US

(21) Appl. No.: 11/793,289

(22) PCT Filed: Sep. 26, 2006
(86) PCT No.: PCT/JP2006/319019

§ 371 Date: Oct. 22, 2007

(30) Foreign Application Priority Data
Dec. 15, 2005 (JP) 2005-361741

(51) Int. Cl. F16B 19/02

(52) U.S. Cl. 16/2.1

(57) ABSTRACT

A stabilizer bush includes an elastic body having an axial hole formed therein for inserting and holding a torsion part of a stabilizer, and an outer peripheral face which is adapted to hold a bracket attached to a vehicle body. The axial hole is configured so that inner diameters thereof gradually decrease from a center part toward outsides in axial directions.

### FIELD OF THE INVENTION

The present invention relates to a stabilizer bush for holding a torsion part of a vehicular stabilizer (also called an anti-roll bar).

### RELATED ART

Conventionally, in a torsion part of a vehicular stabilizer is inserted a vibration absorbing stabilizer bush consisting of an elastic body made of rubber formed approximately cylindrically and the torsion part is attached to a vehicle body by a bracket.

Thus a stabilizer is attached to a vehicle body, making a stabilizer bush intervene, and thereby buffers a vibration and shock of the body. Then as the stabilizer in a patent document 1, at left and right opening ends of an axial hole are respectively formed lips closely contacting the stabilizer. The stabilizer bush prevents such earth and sand, dust, and muddy water from invading a sliding face between itself and the stabilizer in the axial hole by the lips.

FIG. 10 is an enlarged section view of a main part showing a state of a conventional stabilizer bush being attached.

As shown in FIG. 10, a stabilizer bush 100 is thick-cylindrically formed, consisted of a rubber-made elastic body containing a lubricant, and at a center part of the bush 100 is drilled an axial hole 110 for inserting and holding a stabilizer 200. In the stabilizer bush 100 its outer face is formed into an approximately U-letter shape in side view, and a slit 130 is formed for press fitting and building the stabilizer 200 in the axial hole 110 from outer peripheral faces 120.

At both ends in vehicular left and right directions of the stabilizer bush 100 are respectively formed flanges 140; a bracket (not shown) for attaching the bush 100 to the vehicle body is engaged between the brackets 140, and the bush 100 is fixed to the vehicle body by the bracket through bolts.

In addition, the stabilizer bush 100 is normally formed, having a constant fastening range, and by the range being compressed, the bush 100 is firmly attached to the vehicle body.

### DISCLOSURE OF THE INVENTION

### Problems to be Solved by the Invention

However, in the stabilizer bush as shown in the Utility Model Laid-Open Publication No. H 04-11710, there is a problem that the lips tend to deteriorate by a depression-form gap being formed between a reverse side of each of the lips and the stabilizer.

Furthermore, the lips are formed from a thin-form protrusion piece, and thereby tend to be elastically deformed. Therefore, in the stabilizer bush a rigidity of the opening ends of the axial hole lowers; in some case the stabilizer vibrates, is elastically deformed, and a gap is generated between the stabilizer and the bush due to up and down movements of left and right wheel suspensions during running. Whereat, earth and sand invades an inside of the lips through the gaps, and stays in the depression-form gap inside the lips in some case.

When earth and sand stays inside a lip, there are problems that: a friction increases due to the earth and sand, and a sound (abnormal sound) like a stick-slip sound is generated; the earth and sand grinds a coating film of a stabilizer and prompts its rust degradation; and the earth and sand damages a metal surface of the stabilizer and lowers its reliability.

Generally, in order to prevent earth and sand from invading between a stabilizer bush and a stabilizer, it is cited to enlarge a fastening range between them.

However, in a case of enlarging a fastening range, there is a problem that when a stabilizer makes a rotational movement, a friction increases and an operation stability and riding comfort of an automobile lower; therefore the range cannot be enlarged.

Furthermore, in the stabilizer bush having such the slit 130 as shown in FIG. 10, because the bush is easily deformed according to a gap of the slit 130 being formed, there is a problem that a gap S is formed between the axial hole 110 and the stabilizer 200; therefore, such earth and sand, dust, and muddy water tend to invade the gap S.

Consequently, the present invention is intended to solve the problems, and provides a stabilizer bush for preventing such earth and sand, dust, and muddy water from invading a contact face between an axial hole of the bush and a stabilizer while maintaining an operation stability and riding comfort of an automobile.

### Means to Solve the Problems

In order to solve the problems, a stabilizer bush recited in claim 1 is configured to insert and hold a torsion part of a stabilizer in an axial hole formed in an elastic body and to hold an outer peripheral face of the elastic body by a bracket attached to a vehicle body, and in the axial hole an inner diameter is configured to gradually decrease from a center part toward outsides in axial directions.

In accordance with the invention recited in claim 1, in the axial hole of the stabilizer bush is formed the diameter to gradually decrease from the center part toward the outsides in the axial directions. Thus left and right opening end sides of the axial hole comparatively strongly becomes in close contact with a sliding face of the stabilizer; a center side thereof comparatively weakly slides in contact with the sliding face. As the result, because the left and right opening end sides of the axial hole closely contact the stabilizer and are occluded, an invasion of such earth and sand, dust, and muddy water is prevented.

A stabilizer bush recited in claim 2 is the stabilizer bush recited in claim 1, wherein the axial hole is continuously formed in a circumferential direction.

In accordance with the invention recited in claim 2, the axial hole of the stabilizer bush is continuously formed in the circumferential direction, and thereby such a slit is not formed. Therefore, because it is possible to suppress a contact face between the axial hole and the stabilizer from being deformed, it is possible to more surely prevent such earth and sand, dust, and muddy water from invading an inside of the axial hole.

A stabilizer bush recited in claim 3 is the stabilizer bush recited in claim 1 or 2, wherein at side ends in the axial directions of the elastic body are formed grooves along opening ends of the axial hole.

In accordance with the invention recited in claim 3, at the side ends in the axial directions of the elastic body are formed the grooves along the opening ends of the axial hole, and thereby the opening ends of the axial hole tend to be elastically deformed by an amount of the grooves being formed. Therefore, when press fitting the stabilizer in the axial hole, vicinities of the both opening ends of the hole are elastically deformed and closely contact a sliding face of the stabilizer; thus it is possible to prevent such earth and sand, dust, and muddy water from invading the face.

A stabilizer bush recited in claim 4 is the stabilizer bush recited in any one of claims 1 to 3, wherein an axis is curved outward from one end of the bush in an axial direction.

In accordance with the invention of claim 4, the axis is curved outward from one end of the bush in the axial direction, and thereby vicinities of the opening ends closely contact the stabilizer; therefore, it is possible to stably ensure a fastening range. Moreover, even if an excessive stress is applied to the one opening end, the vicinity thereof is prevented from being deformed as if being bent; therefore, it is eliminated for a strain to locally occur.

A stabilizer bush recited in claim 5 is the stabilizer bush recited in any one of claims 1 to 4, wherein a lubricant is coated inside the axial hole.

In accordance with the invention of claim 5, the lubricant is coated inside the axial hole, and thereby in the stabilizer bush a friction coefficient inside the axial hole is lowered and the bush tends to be deformed as if its whole undulates; therefore, even if an excessive stress is applied to the opening ends, the bush is prevented from being locally deformed. Furthermore, because the lubricant is water repellent, an invasion of muddy water is prevented.

A stabilizer recited in claim 6 is the stabilizer recited in claim 5, wherein a depression configured to reserve the lubricant is formed inside the axial hole.

In accordance with the invention of claim 6, the depression configured to reserve the lubricant is formed inside the axial hole, and thereby, even if an oil in the vicinities of the opening ends is washed away by muddy water, the lubricant reserved in the depression is supplied thereto; thus, the water repellency of the stabilizer bush is held for a long time.

In accordance with the stabilizer bush of the present invention, while maintaining an operation stability and riding comfort of an automobile, it is possible to hold a durability of the opening ends of the axial hole, to closely contact the contact face between the axial hole of the bush and the stabilizer, and to prevent such earth and sand, dust, and muddy water from invading the inside of the axial hole.

### EFFECT OF THE INVENTION

In accordance with a stabilizer bush of the present invention it is possible to hold a durability of an opening end of an axial hole, to make the axial hole of the stabilizer bush contact a contact face with the stabilizer, and to prevent such earth and sand, dust, and muddy water from invading in the axial hole, while maintaining an operation stability and riding comfort of an automobile.

### BRIEF DESCRIPTION OF THE DRAWINGS

FIG. 1 is a perspective view of a stabilizer showing an installation state of a stabilizer bush related to an embodiment of the present invention.

FIGS. 2A and 2B are drawings showing the stabilizer bush related to the embodiment of the present invention; FIG. 2A is an enlarged section view; and FIG. 2B is an enlarged side view.

FIGS. 3A and 3B are drawings showing the stabilizer bush related to the embodiment of the present invention; FIG. 3A is an enlarged section view showing a built-in state of the bush; and FIG. 3B is an enlarged section view showing a state of a larger load being applied to the stabilizer.

FIG. 4 is a drawing that shows the stabilizer bush related to the embodiment of the present invention and is an enlarged section view of a main part showing a state of a particle such as earth and sand having invaded an inside of an axial hole.

FIGS. 5A and 5B are drawings showing a first modification example of the stabilizer bush related to the embodiment of the present invention; FIG. 5A is an enlarged section view; and FIG. 5B is an enlarged side view.

FIGS. 6A and 6B are drawings showing the first modification example of the stabilizer bush related to the embodiment of the present invention; FIG. 6A is an enlarged section view showing a built-in state of the bush; and FIG. 6B is an enlarged section view showing a state of a larger load being applied to the stabilizer.

FIG. 7 is an enlarge section view showing a second modification example of the stabilizer bush related to the embodiment of the present invention.

FIG. 8 is an enlarge section view showing a third modification example of the stabilizer bush related to the embodiment of the present invention.

FIG. 9 is an enlarge section view showing a fourth modification example of the stabilizer bush related to the embodiment of the present invention.

FIG. 10 is an enlarged section view of a main part showing a state of a conventional stabilizer bush being attached.

### DESCRIPTION OF ALPHANUMERALS

### Stabilizer

2a Torsion Part
2b Bent Part
4, 6, 7, 8, 9 Stabilizer Bush
4a, 6a, 7a, 8a, 9a Elastic Body
4b, 6b, 7b, 8b, 9b Axial Hole
4c Outer Peripheral Face
4e, 6d, 7c, 8c, 9c Opening End

### Bracket

6c End
6e Groove Part
9d Depression
d1, d2 Inner Diameter
La, Lb Lubricant

### BEST MODE FOR CARRYING OUT THE INVENTION

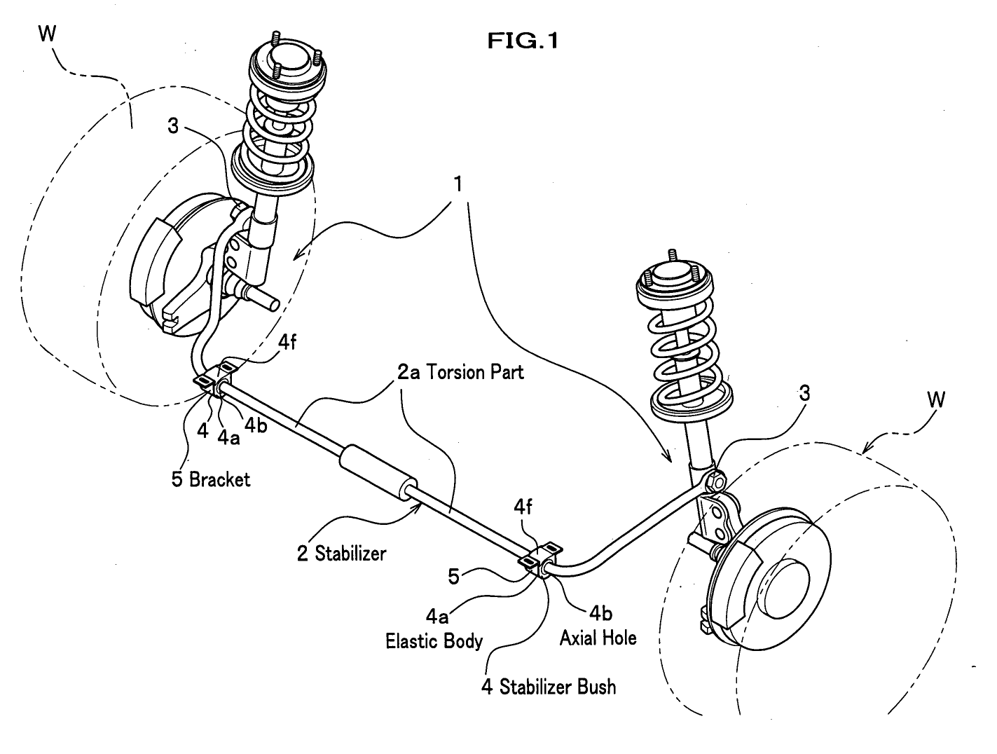

Next will be described a stabilizer bush related to an embodiment of the present invention, referring to FIGS. 1 to 4. FIG. 1 is a perspective view of a stabilizer showing an installation state of a stabilizer bush related to an embodiment of the present invention.

### <<Configuration of Stabilizer>>

As shown in FIG. 1, a stabilizer 2 suppresses a rolling of a vehicle body when a vehicle swivels, and is attached to independent suspensions 1 of the body so that respective left and right wheels W can move independently. The stabilizer 2 comprises torsion parts 2a composed of a bar-form spring member, and at left and right ends thereof are formed bolt insertion holes (not shown) for fastening respective torsion parts 2a with bolts 3. On each of the left and right parts of the stabilizer 2 is fitted a stabilizer bush 4.

### <<Configuration of Stabilizer Bush>>

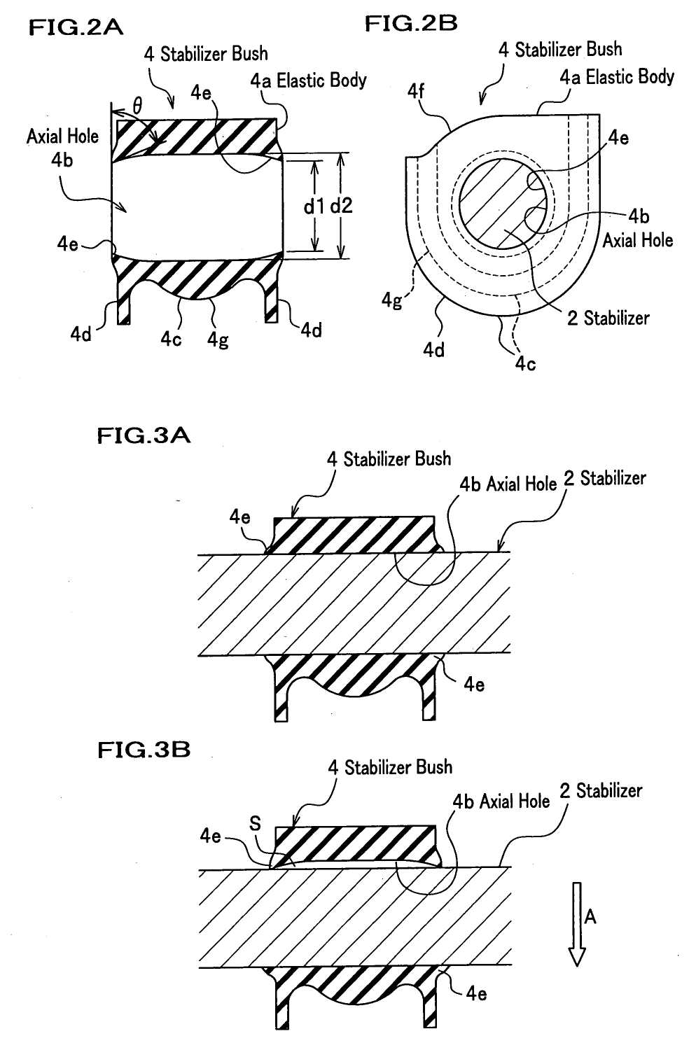

As shown in FIG. 1, in each of the stabilizer bushes 4 an end of the stabilizer 2 is pushed in an axial hole 4b drilled in an elastic body 4a, moved to the torsion part 2a, and held there. A bracket 5 attached to the vehicle body is loaded on an outer peripheral face 4c (see FIGS. 2A and 2B) of the elastic body 4a for forming the stabilizer bush 4.

FIGS. 2A and 2B are drawings showing the stabilizer bush related to the embodiment of the present invention; FIG. 2A is an enlarged section view; and FIG. 2B is an enlarged side view.

As shown in FIGS. 2A and 2B, in the stabilizer bush 4 is drilled the axial hole 4b where the stabilizer 2 is inserted in left and right lateral directions. The stabilizer bush 4 is formed into a thick cylindrical form with, for example, the elastic body 4a for vibration absorption made of rubber containing a lubricant.

As shown in FIG. 2A, at both ends in left and right directions, the stabilizer bush 4 respectively has flange parts 4d engaged by the bracket 5 (see FIG. 1) of which a section is approximately an Ω-letter form, and is fixed to the vehicle body by fastening the bracket 5 to the body with bolts. Between the left and right flange parts 4d is formed a curved-surface form convex part 4g where the bracket 5 is pressed.

As shown in FIG. 2B, in the side view of the stabilizer bush 4 the outer peripheral face 4c is formed into an approximately U-letter form, and a top face 4f is formed into a curved-surface form.

As shown in FIG. 2A, in the axial hole 4b inner diameters d2 gradually are decreased to inner diameters d1 from a center part toward outsides in axial directions, and the axial hole 4b is continuously formed in a circumferential direction. In other words, in the axial hole 4b the inner diameters d1 at left and right opening ends 4e is are formed smaller than the inner diameter d2 at the center part. Therefore, an angle θ at the left and right opening ends 4e is formed into an acute angle slightly smaller than 90 degrees.

FIGS. 3A and 3B are drawings showing the stabilizer bush related to the embodiment of the present invention; FIG. 3A is an enlarged section view showing a built-in state of the bush; and FIG. 3B is an enlarged section view showing a state of a larger load being applied to the stabilizer.

Then as shown in FIGS. 2, 3A, and 3B, when the stabilizer 2 is inserted and built in the axial hole 4b, it is designed to be built in a state of vicinities of the opening ends 4e of the stabilizer bush 4 being pressed, always in close contact with the stabilizer 2.

### <<Action of Stabilizer Bush>>

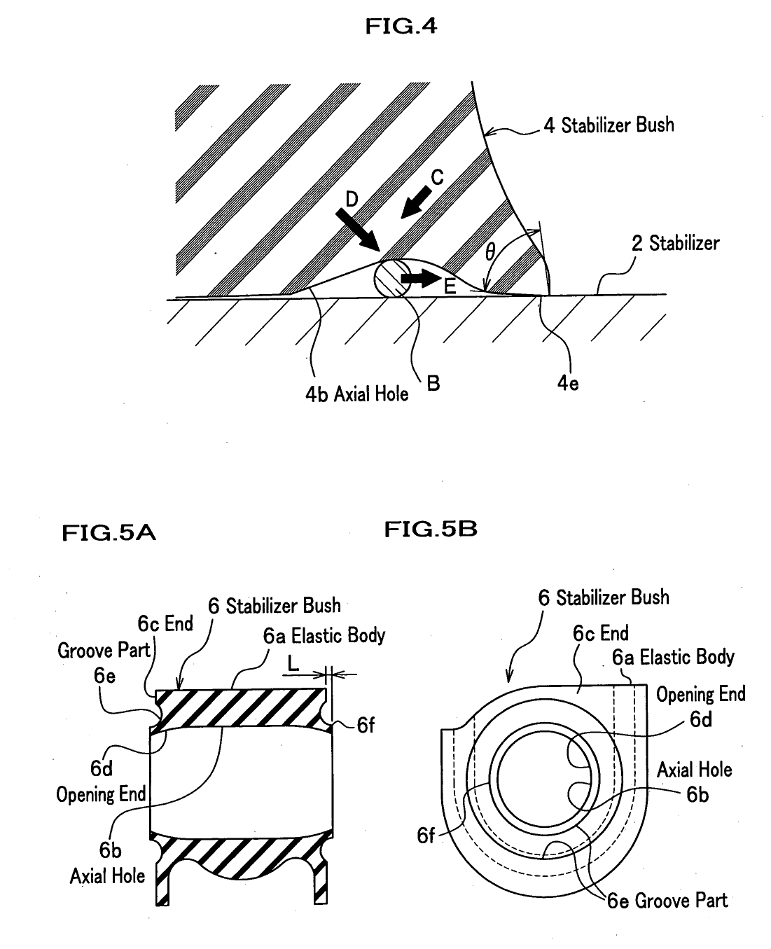

Next will be described an action of the stabilizer bush 4 related to the embodiment of the present invention, mainly referring to FIGS. 3A, 3B, and 4.

In a case that a normal load is applied to the stabilizer 2 where the stabilizer bush 4 is press fitted; as shown in FIG. 3A, the opening ends 4e of the axial hole 4b receive a comparatively large force and are pressed against the stabilizer 2, and the center part of the axial hole 4b is pressed against the stabilizer 2 through a comparatively small force.

In the stabilizer bush 4, for example, due to a lateral force in swivel running, a larger load is applied to the stabilizer 2 in a downward direction of an arrow mark A shown in FIG. 3B. Whereat, because the stabilizer bush 4 receives the larger load of from the stabilizer 2 on a lower face of the bush 4 in the axial hole 4b, the stabilizer 2 is pressed onto the lower face in the hole 4b and is deformed as if being crushed; thus there occurs a slight gap S at an upper center part in the axial hole 4b. Then to the left and right opening ends 4e is applied a larger load by an amount of inner diameter d1 at the outsides being smaller than the inner diameter d2 at the center part; thus the ends 4e are deformed as if being crushed, and closely in contact with the stabilizer 2 (see FIG. 2A). In addition, FIG. 3B exaggeratedly shows the gap S to depict it.

Thus in the stabilizer bush 4 the left and right opening ends 4e are always closely in contact with the stabilizer 2, and are in a state of being pressed. As the result, the stabilizer bush 4 can prevent such earth and sand, dust, and muddy water from invading an inside of the axial hole 4b; and prevent the earth and sand from entering the hole 4b, sliding in contact with the stabilizer 2, and generating an abnormal sound.

Furthermore, when building each stabilizer bush 4 in the vehicle body, the convex part 4g is closely in contacts with the bracket 5 shown in FIG. 1 and the top face 4f closely contacts the body; therefore, there does not occur such a backlash.

Furthermore, as shown in FIG. 2A, in the axial hole 4b the diameter gradually decreases from the inner diameters d2 to d1 from the center part toward the outsides in the axial directions, and the hole 4b is continuously formed in the circumferential direction, it is possible to make a fastening range of the stabilizer 2 larger (see FIGS. 3A and 3B).

As a result thereof, as shown in FIG. 3B, even in a case that a larger load is applied and the stabilizer bush 4 is largely moved, the opening ends 4e are held in close contact with the stabilizer 2 and do not open; therefore, it is possible to surely prevent the invasion of such earth and sand.

Next will be described an action in a case that a particle B such as earth and sand invades an inside of the stabilizer bush 4 by any chance, referring to FIG. 4.

FIG. 4 is a drawing that shows the stabilizer bush related to the embodiment of the present invention and is an enlarged section view of a main part showing a state of a particle such as earth and sand having invaded an inside of an axial hole.

For example, as shown in FIG. 4, when the particle B such as earth and sand invades the inside of the stabilizer bush 4 by any chance, a larger load from the stabilizer 2 is loaded on a lower face within the axis hole 4b of the stabilizer bush 4 if the larger load is applied to the stabilizer 2 in a downward direction (arrow mark A direction shown in FIG. 3B). In this case the angle θ at the opening end 4e of the axial hole 4b is the acute angle, the end 4e is formed into a thin state, the inner diameter of the bush 4 gradually decreases toward the outside, and the bush 4 is formed thin in thickness (see FIG. 2A). Then, a force acts on the opening end 4e so that the end 4e is bent upward, and there occurs a force in an arrow mark C direction shown in FIG. 4. Therefore, the opening end 4e pushes the particle B such as the earth and sand with a smaller surface pressure C in an obliquely inward direction. [0043] Then from an inside more than the particle B such as the earth and sand, a thickness of the stabilizer bush 4 becomes larger, and thereby the bush 4 pushes the particle B with a surface pressure D larger than the surface pressure C in an obliquely outward direction.

As a result thereof, in such the earth and sand B there occurs a force in an arrow mark E direction due to the larger surface pressure D. Therefore, the particle B moves in an outward direction of an arrow mark E along a surface of the stabilizer 2 by the larger surface pressure D and is discharged outside the axial hole 4b. Thus even if the particle B such as the earth and sand invades the inside of the axial hole 4b by any chance, the stabilizer bush 4 has a function of discharging the particle B outside by the forces of the surface pressures C and D that act in the gradient directions.

In addition, it goes without saying that: the present invention is not limited to the embodiment; can be modified and changed within the spirit and scope of the invention; and also covers the modified and changed inventions.

### MODIFICATION EXAMPLES

Next will be sequentially described first to fourth modification examples of the stabilizer bush 4 related to the embodiment of the present invention, referring to FIGS. 5A to 9.

### First Modification Example

FIGS. 5A and 5B are drawings showing the first modification example of the stabilizer bush related to the embodiment of the present invention; FIG. 5A is an enlarged section view; and FIG. 5B is an enlarged side view.

Like a stabilizer bush 6 as shown in FIGS. 5A and 5B, groove parts 6e may be formed at ends 6c of sides in an axial direction of an elastic body 6a along opening ends 6d of an axial hole 6b.

In this case the groove parts 6e are annularly formed in vicinities of the opening ends 6d, respectively. Each groove part 6e is composed of an approximately semicircular groove. Furthermore, as shown in FIG. 5A, at each opening end 6d is formed an annular protrusion piece 6f protruding outside by a length L.

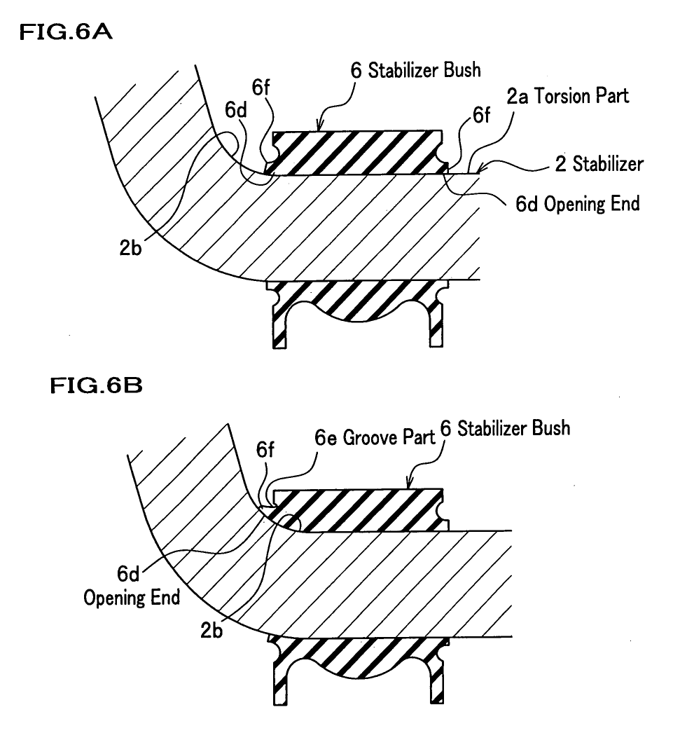

FIGS. 6A and 6B are drawings showing the first modification example of the stabilizer bush related to the embodiment of the present invention; FIG. 6A is an enlarged section view showing a built-in state of the bush; and FIG. 6B is an enlarged section view showing a state of a larger load being applied to the stabilizer.

In the stabilizer 2, as shown in FIG. 6A, is formed a bent part 2b curved outward from one end of an axial direction in some case, so that the stabilizer bush 6 does not move not less than a predetermined range with respect to the stabilizer 2.

In such the case, as shown in FIG. 6B, the stabilizer bush 6 moves to the side of the bent part 2b of the stabilizer 2 in some case, the annular protrusion piece 6f of the opening end 6d mounts on the bent part 2b, and the bush 6 is deformed as if being warped.

In such the case, in the stabilizer bush 6 the annular groove 6e is formed along the vicinity of the opening end 6d, and thereby a compression deformation of the annular protrusion piece 6f is reduced; therefore, the bush 6 can prevent an occurrence of such a wrinkle.

Thus the annular groove 6e of the stabilizer bush 6 is formed in the vicinity of the opening end 6d, and thereby the groove 6e is deformed into a curved form and not buckled; therefore, it is possible to prevent an excessive stress from being applied to the end 6d and to enhance the durability of the bush 6.

### Second Modification Example

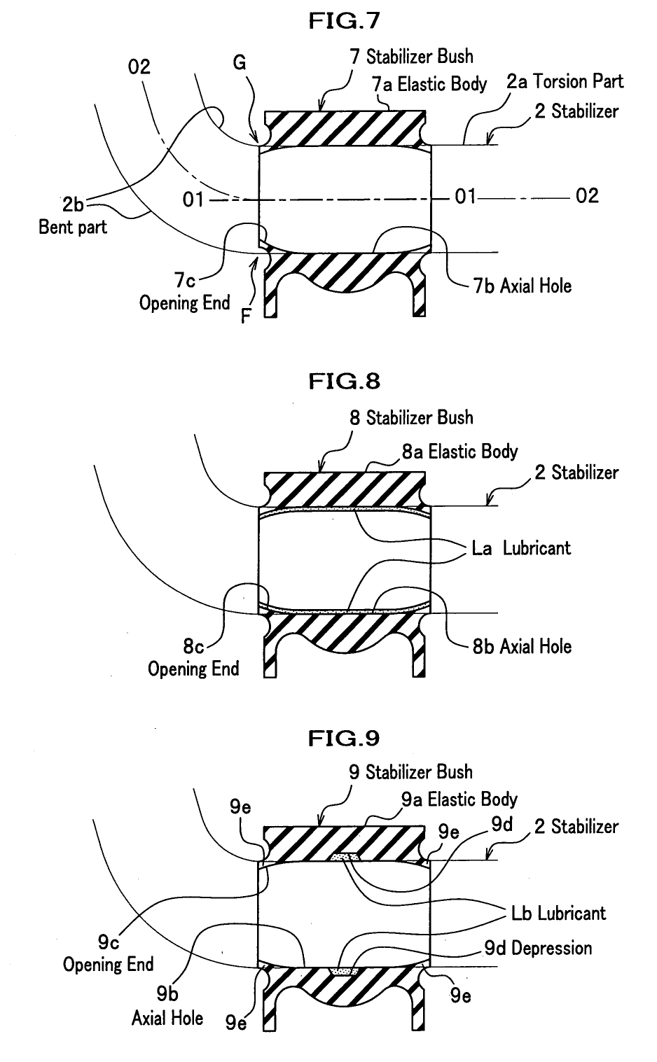

FIG. 7 is an enlarge section view showing the second modification example of the stabilizer bush related to the embodiment of the present invention.

As shown in FIG. 7, in a stabilizer bush 7 a center axis O1-O1 may curve outward from one opening end 7c of an axial direction, approximately matching a shape of the bent part 2b formed at the torsion part 2a of the stabilizer 2. Then in an axial hole 7b of an elastic body 7a a vicinity of at least the opening end 7c at a side of the bent part 2b in the hole 7b is formed into a state of being curved and bent outward.

In other words, the center axis O1-O1 of the stabilizer bush 7 is bent approximately along a center axis O2-O2 of the bent part 2b of the stabilizer 2. In this case, as shown in FIG. 7, the vicinity of the opening end 7c is curved, and thereby the end 7c is formed into a state of being opened in an oblique direction.

Thus the vicinity of the opening end 7c of the stabilizer bush 7 curves outward and is formed, matching the shape of the stabilizer 2, and thereby an outside corner part F in the vicinity of the end 7c closely contacts the stabilizer 2; therefore, it is possible to stably ensure a fastening range of the bush 7.

Moreover, an inside corner part G in the vicinity of the opening end 7c is formed, matching the shape of the stabilizer 2, and thereby it is eliminated to invite a fatigue deterioration of the rubber due to a locally large strain caused by an excessive stress being applied to the end 7c; therefore, it is possible to enhance the durability of the stabilizer bush 7.

### Third Modification Example

FIG. 8 is an enlarge section view showing the third modification example of the stabilizer bush related to the embodiment of the present invention.

Like a stabilizer bush 8 shown in FIG. 8, inside an axial hole 8b of an elastic body 8a may be coated a lubricant La such as a silicone oil and a silicone grease having non attacking property to the rubber and a water repellency.

Thus by coating the lubricant La inside the axial hole 8b, a friction coefficient inside the hole 8b of the stabilizer bush 8 lowers and a whole of the bush 8 tends to be deformed as if being undulated; therefore, even if an excessive stress is applied to opening ends 8c, a local deformation of the bush 8 is prevented, and thus it is possible to enhance the durability thereof.

Furthermore, by coating a fat (lubricant La) with the water repellency inside the axial hole 8b, it is possible to more effectively prevent the invasion of muddy water.

### Fourth Modification Example

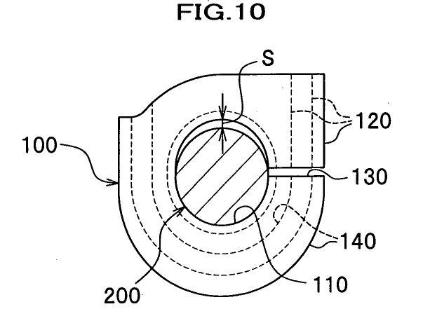

FIG. 9 is an enlarge section view showing the fourth modification example of the stabilizer bush related to the embodiment of the present invention.

Like a stabilizer bush 9 shown in FIG. 9, inside an axial hole 9b of an elastic body 9a may be formed a depression 9d for reserving a lubricant Lb composed of such a grease or a high viscosity oil. In this case the depression 9d is composed of an annular groove or an intermittent groove formed at a center part inside the axial hole 9b.

Thus is formed the depression 9d for reserving the lubricant Lb inside the axial hole 9b, and thereby, even if an oil at seal parts 9e is washed away in vicinities of opening ends 9c, the lubricant Lb reserved in the depression 9d is stably supplied to the seal parts 9e and the water repellency of the stabilizer bush 9 is held for a long time.

### Other Modification Examples

Although in the embodiments descriptions have been made citing the symmetric stabilizer bushes 4 and 6-9 as the examples, it is not necessary to make them the symmetric shapes; their shapes may be changed as needed.

Furthermore, the axial holes 4b and 6b to 9b may be formed so that an inner diameter gradually decreases from the center part toward the outsides in the axial directions; for example, the holes 4b and 6b to 9b ma be formed into a taper form from the center part toward the respective opening ends 4e, 6d, and 7c to 9c inside them; or only the vicinities of the ends 4e, 6d, and 7c to 9c inside the respective axial holes 4b and 6b to 9b may be formed into a taper form.

1. A stabilizer bush comprising an elastic body having an axial hole formed therein for inserting and holding a torsion part of a stabilizer, and an outer peripheral face which is adapted to hold a bracket attached to a vehicle body,
wherein the axial hole being configured to gradually decrease in an inner diameter thereof from a center part toward outsides in axial directions of the hole.

2. The stabilizer bush according to claim 1, wherein the axial hole is continuously formed in a circumferential direction.

3. The stabilizer bush according to claim 1, wherein at side ends in the axial directions of the elastic body are formed grooves along opening ends of the axial hole.

4. The stabilizer bush according to claim 1, wherein an axis of the elastic body is curved outward from one end of the bush in an axial direction.

5. The stabilizer bush according to claim 1, wherein a lubricant is coated inside the axial hole.

6. The stabilizer bush according to claim 5, wherein the elastic body has a depression configured to reserve the lubricant is formed inside the axial hole.

7. The stabilizer bush according to claim 2, wherein at side ends in the axial directions of the elastic body are formed grooves along opening ends of the axial hole.

8. The stabilizer bush according to claim 2, wherein an axis of the elastic body is curved outward from one end of the bush in an axial direction.

9. The stabilizer bush according to claim 3, wherein an axis of the elastic body is curved outward from one end of the bush in an axial direction.

10. The stabilizer bush according to claim 2, wherein a lubricant is coated inside the axial hole.

11. The stabilizer bush according to claim 3, wherein a lubricant is coated inside the axial hole.

12. The stabilizer bush according to claim 4, wherein a lubricant is coated inside the axial hole.

13. The stabilizer bush according to claim 10, wherein the elastic body has a depression configured to reserve the lubricant is formed inside the axial hole.

14. The stabilizer bush according to claim 11, wherein the elastic body has a depression configured to reserve the lubricant is formed inside the axial hole.

15. The stabilizer bush according to claim 12, wherein the elastic body has a depression configured to reserve the lubricant is formed inside the axial hole.
